(19) United States
(12) Patent Application Publication
(10) Pub. No.: US 2026/0254294 A1
(43) Pub. Date: Aug. 27, 2026

(54) MOTOR AND ORAL CLEANING DEVICE

(71) Applicant: Shenzhen Soocas Technology Co., Ltd., Shenzhen (CN)

(72) Inventors: Yanqiang LI, Shenzhen (CN); Mengwei ZENG, Shenzhen (CN); Yi XIE, Shenzhen (CN); Zhoujian LI, Shenzhen (CN)

(73) Assignee: Shenzhen Soocas Technology Co., Ltd., Shenzhen (CN)

(21) Appl. No.: 19/428,431

(22) Filed: Dec. 22, 2025

Related U.S. Application Data
(63) Continuation of application No. PCT/CN2025/114487, filed on Aug. 13, 2025.

(30) Foreign Application Priority Data
Feb. 27, 2025 (CN) 202510238478.6

(51) Int. Cl. H02K 1/17; A61C 17/26; H02K 1/24; H02K 1/26; H02K 3/34

(52) U.S. Cl. CPC H02K 1/17; A61C 17/26; H02K 1/24; H02K 1/26; H02K 3/345; H02K 2213/03

(57) ABSTRACT

The present disclosure relates to a motor and an oral cleaning device. The motor according to the present disclosure includes a rotor shaft, a rotor member, a stator assembly, and two groups of magnets, wherein the rotor member is fixedly arranged on the rotor shaft and has two winding mounting arms extending in opposite directions in a radial direction of the rotor shaft, and the winding mounting arms are configured to mount windings; the stator assembly is arranged around the rotor member; the two groups of magnets are arranged on the stator assembly and correspond to the two winding mounting arms respectively, and each group of magnets includes two magnets with opposite magnetic properties; in at least one plane perpendicular to a rotation axis of the rotor shaft, a central angle α of central lines of the two magnets in the same group ranges from 40° to 50° with an intersection point of the rotation axis and the plane as a circle center.

### CROSS REFERENCE TO RELATED APPLICATION

This application is a continuation of International Application No. PCT/CN2025/114487, filed on Aug. 13, 2025, which claims priority to Chinese Patent Application No. 2025102384786 titled “MOTOR AND ORAL CLEANING DEVICE” filed on Feb. 27, 2025, the entire contents of which are incorporated herein by reference.

### TECHNICAL FIELD

The present disclosure relates to the field of oral cleaning device technologies, and in particular, to a motor and an oral cleaning device.

### BACKGROUND

In an electric toothbrush, a brush head generates high-frequency vibrations through rapid rotation or vibrations of a motor, so as to effectively clean teeth and the oral cavity, and compared with a traditional toothbrush, a cleaning capability is improved, and therefore, the electric toothbrush becomes increasingly popular with consumers.

The motor of the existing electric toothbrush has a small swing amplitude, and surfaces of the teeth cannot be effectively cleaned. For example, the world-recognized Pasteur brushing method requires that angles between bristles and the teeth are 45-60 degrees, and therefore, how to increase the swing amplitude of the motor of the electric toothbrush is an urgent problem to be solved in the art.

### SUMMARY

An object of the present disclosure is to provide a motor and an oral cleaning device to overcome deficiencies in the prior art.

In a first aspect, the present disclosure provides a motor, including:
a rotor shaft;
a rotor member fixedly arranged on the rotor shaft and having two winding mounting arms extending in opposite directions in a radial direction of the rotor shaft, the winding mounting arms being configured to mount windings;
a stator assembly arranged around the rotor member; and
two groups of magnets arranged on the stator assembly and corresponding to the two winding mounting arms respectively, each group of magnets including two magnets with opposite magnetic properties;
wherein in at least one plane perpendicular to a rotation axis of the rotor shaft, a central angle α of central lines of the two magnets in the same group ranges from 40° to 50° with an intersection point of the rotation axis and the plane as a circle center.

In an embodiment of the present disclosure, in the at least one plane perpendicular to the rotation axis of the rotor shaft, the central angle α of the central lines of the two magnets in the same group ranges from 44.5° to 45.5° with the intersection point of the rotation axis and the plane as the circle center.

In an embodiment of the present disclosure, in the at least one plane perpendicular to the rotation axis of the rotor shaft, an included angle β between adjacent sides of the two magnets in the same group ranges from 35° to 45°.

In an embodiment of the present disclosure, a single-sided swing angle of the rotor member ranges from 5° to 15°.

In an embodiment of the present disclosure, in the at least one plane perpendicular to the rotation axis of the rotor shaft, a ratio of a minimum value H1 of a side distance of the two magnets in the same group to a width H2 of the corresponding winding mounting arm of the rotor member is 1:(1.15-1.22).

In an embodiment of the present disclosure, in the at least one plane perpendicular to the rotation axis of the rotor shaft, the minimum value H1 of the side distance of the two magnets in the same group is 4 mm to 5 mm.

In an embodiment of the present disclosure, in the at least one plane perpendicular to the rotation axis of the rotor shaft, the minimum value H1 of the side distance of the two magnets in the same group is 4.55 mm to 4.75 mm.

In an embodiment of the present disclosure, in the at least one plane perpendicular to the rotation axis of the rotor shaft, the rotor member includes a circular surrounding portion fixedly wound around the rotor shaft, the winding mounting arm includes an arm rod portion extending from the circular surrounding portion towards the stator assembly in a radial direction, and two stop portions circumferentially extending from the arm rod portion in opposite directions, and the winding is wound around the arm rod portion.

In an embodiment of the present disclosure, at a balanced position, the two magnets of the same group are symmetrically arranged relative to the corresponding arm rod portion of the winding mounting arm, and projections obtained when the two magnets of the same group and the winding mounting arm are subjected to a central projection in the radial direction with a point of the rotation axis as a projection center are partially overlapped.

In an embodiment of the present disclosure, within a range of swinging of the rotor member around the rotor shaft relative to the stator assembly under the action of a magnetic force after the winding is energized, a side of the stator assembly facing the rotor member is an arc surface, a side of the winding mounting arm facing the stator assembly is an arc surface, and a radial air gap between the two arc surfaces ranges from 0.1 mm to 0.2 mm.

In an embodiment of the present disclosure, a groove extending along the rotation axis is formed in the side of the winding mounting arm facing the stator assembly which is the arc surface, and at the balanced position, the groove is located between the two magnets of the same group.

In an embodiment of the present disclosure, the motor further includes an insulating layer, the insulating layer being arranged between the winding and the winding mounting arm of the rotor member.

In an embodiment of the present disclosure, in the at least one plane perpendicular to the rotation axis of the rotor shaft, the width H2 of the winding mounting arm of the rotor member is 5 mm to 6 mm.

In an embodiment of the present disclosure, in the at least one plane perpendicular to the rotation axis of the rotor shaft, the width H2 of the winding mounting arm of the rotor member is 5.45 mm to 5.55 mm.

In an embodiment of the present disclosure, the stator assembly further includes a shell and a fixing base with a shape adapted to that of the shell, and the magnet is fixedly arranged in the fixing base;
in the at least one plane perpendicular to the rotation axis of the rotor shaft, the shell has a swing space for the rotor member to swing around the rotor shaft relative to the magnet, the swing space is defined by two arc sections and two linear sections, the two arc sections are arranged concentrically with the rotation axis of the rotor shaft, and the two linear sections are parallel to an extending direction of the winding mounting arm at the balanced position.

In an embodiment of the present disclosure, in the at least one plane perpendicular to the rotation axis of the rotor shaft, a section of the magnet is in an arc shape, and the magnet includes an outer arc section and an inner arc section distributed in the radial direction, as well as two sides respectively connected with two corresponding ends of the outer arc section and the inner arc section; central angles corresponding to the outer arc section and the inner arc section are the same.

In an embodiment of the present disclosure, in the at least one plane perpendicular to the rotation axis of the rotor shaft, the side has a length of 1 mm to 1.5 mm.

In an embodiment of the present disclosure, the rotor shaft is provided with a fluid channel extending in an extending direction of the rotor shaft.

In an embodiment of the present disclosure, the rotor shaft rotates in a direction of a moment component to a first preset position when driven by the moment component in a circumferential direction of the rotation axis, and subsequently rotates in an opposite direction to a second preset position when driven by a moment component in the opposite direction.

In a second aspect, the present disclosure provides an oral cleaning device, including a body, a cleaning accessory movably arranged on the body, and a motor arranged in the body, wherein the motor is configured to drive the cleaning accessory to swing through a rotor shaft, and the motor is the motor according to any one of the above embodiments.

In an embodiment of the present disclosure, the oral cleaning device further includes a pump, a liquid outlet end of the pump being in communication with the fluid channel of the rotor shaft.

### BRIEF DESCRIPTION OF THE DRAWINGS

The accompanying drawings, which are incorporated in and constitute part of this specification, show embodiments of the present disclosure and together with the description thereof, serve to explain the principles of the present disclosure.

FIG. 1 is a first schematic radial sectional diagram of a motor according to an embodiment of the present disclosure;

FIG. 2 is a second schematic radial sectional diagram of the motor according to an embodiment of the present disclosure;

FIG. 3 is a schematic perspective structural diagram of the motor according to an embodiment of the present disclosure;

FIG. 4 is a schematic axial sectional diagram of the motor according to an embodiment of the present disclosure; and

FIG. 5 is a third schematic radial sectional diagram of the motor according to an embodiment of the present disclosure.

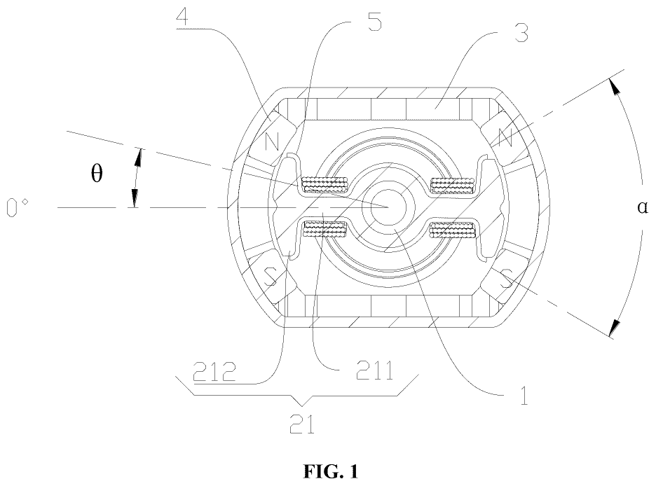

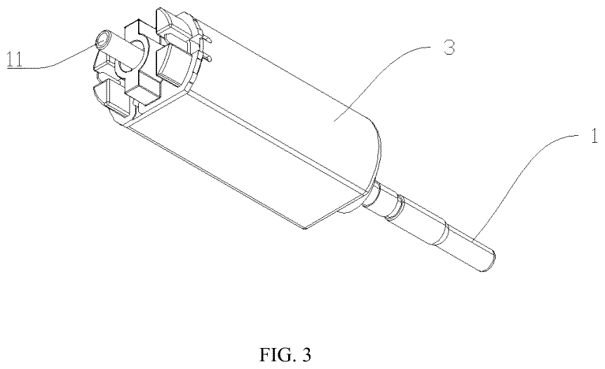

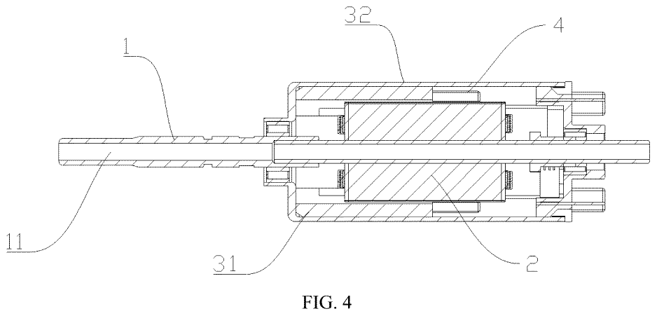

The one-to-one corresponding relationships between assembly names and reference numerals in FIGS. 1 to 5 are as follows:
1—rotor shaft; 11—fluid channel;
2—rotor member; 21—winding mounting arm; 211—arm rod portion; 212—stop portion; 2121—groove;
22—winding; 23—circular surrounding portion;
3—stator assembly; 31—fixing base; 32—shell;
4—magnet; 5—insulating layer.

### DETAILED DESCRIPTION

Various exemplary embodiments of the present disclosure will now be described in detail with reference to the accompanying drawings. It should be noted that the relative arrangement of the components and steps, the numerical expressions, and the numerical values set forth in embodiments do not limit the scope of the present disclosure unless specifically stated otherwise.

The following description of at least one exemplary embodiment is merely illustrative in nature and is in no way intended to limit the present disclosure and applications or uses thereof.

Technologies, methods, and devices known to one of ordinary skill in the relevant art may not be discussed in detail but should be regarded as part of the specification where appropriate.

In all examples shown and discussed herein, any particular value should be construed as exemplary only and not as limiting. Therefore, other examples of exemplary embodiments may have different values.

It should be noted that like reference numbers and letters refer to like items in the following drawings, and thus, once an item is defined in one drawing, it is not required be discussed further in subsequent drawings.

Herein, “upper”, “lower”, “front”, “rear”, “left”, “right”, or the like, are used only to indicate relative positional relationships between relevant parts, and do not limit absolute positions of the relevant parts.

Herein, “first”, “second”, or the like, are used only for distinguishing one from another, and do not indicate the degree and order of importance, mutual prerequisites for each other, or the like.

Herein, “equal”, “same”, or the like, are not strictly mathematical and/or geometric limitations, but also encompass errors that may be understood by one skilled in the art and that may be allowed for manufacturing or use, etc.

FIGS. 1, 2 and 5 herein are the same schematic sectional diagram, and for clarity of structure and size parameters, are named a first schematic radial sectional diagram, a second schematic radial sectional diagram, and a third schematic radial sectional diagram.

It should be noted that, in order to facilitate a better understanding of the technical solution of the present disclosure, first, the directional word setting rules and the technical terms related to the present disclosure are described first.

In the present disclosure, “axial” refers to a direction along the rotation axis of the rotor shaft, “circumferential” refers to a circumferential direction around the rotation axis of the rotor shaft, and “radial” refers to a direction extending outwards from the rotation center in the plane perpendicular to the rotation axis of the rotor shaft.

Cogging torque: torque generated by interaction between a permanent magnet and a stator core when a permanent magnet motor winding is not energized, and caused by a tangential component of an interaction force between the permanent magnet and armature teeth.

Duty ratio: a ratio of an energization time to a total time within one pulse cycle.

A motor of an existing electric toothbrush has a small swing amplitude, and therefore, the present disclosure provides a motor and an oral cleaning device. For ease of understanding, specific structures and working principles of the motor and the oral cleaning device according to the present disclosure are described in detail below with reference to FIGS. 1 to 5 in conjunction with embodiments.

The motor according to the present disclosure includes a rotor shaft 1, a rotor member 2, a stator assembly 3, and two groups of magnets, wherein the rotor member 2 is fixedly arranged on the rotor shaft 1 and has two winding mounting arms 21 extending in opposite directions in a radial direction of the rotor shaft 1, and the winding mounting arms 21 are configured to mount windings 22; the stator assembly 3 is arranged around the rotor member 2; the two groups of magnets are arranged on the stator assembly 3 and correspond to the two winding mounting arms 21 respectively, and each group of magnets includes two magnets 4 with opposite magnetic properties; in at least one plane perpendicular to a rotation axis of the rotor shaft 1, a central angle α of central lines of the two magnets 4 in the same group ranges from 40° to 50° with an intersection point of the rotation axis and the plane as a circle center.

For the motor according to the present disclosure, due to existence of cogging torque, the larger a swing angle is, the smaller an electromagnetic force is, and in the motor, special structure setting is used to adjust the central angle α of the central lines of the two magnets 4 in the same group to change a distance between the two magnets 4, the larger the central angle α is, the larger the distance between the magnets 4 is, and meanwhile, the farther the magnet 4 is form a central position of the winding mounting arm 21, the cogging torque is reduced, and the electromagnetic force of the motor is increased, thereby increasing the reciprocating swing angle. Since the cogging torque is reduced, the electromagnetic force of the motor for overcoming the cogging torque in a rotating process is reduced, and the electromagnetic force acting on output torque of the motor is increased, such that an efficiency of the motor is improved, the output torque of the motor is improved, and a load resisting capability of the motor is improved.

When the motor is not energized to work, the rotor member 2 is located at an initial position, and at this point, the central position of the winding mounting arm 21 is farthest from the magnet 4, and the cogging torque is minimal. Since the cogging torque is small during starting, a starting characteristic of the motor is better, and when electromagnetic torque of the motor overcomes the cogging torque for outputting, the swing angle of the rotor member 2 can be controlled, an electromagnetic conversion process is relatively simple and straightforward, and when a control signal is received, the motor can react quickly to realize a change of a rotation angle.

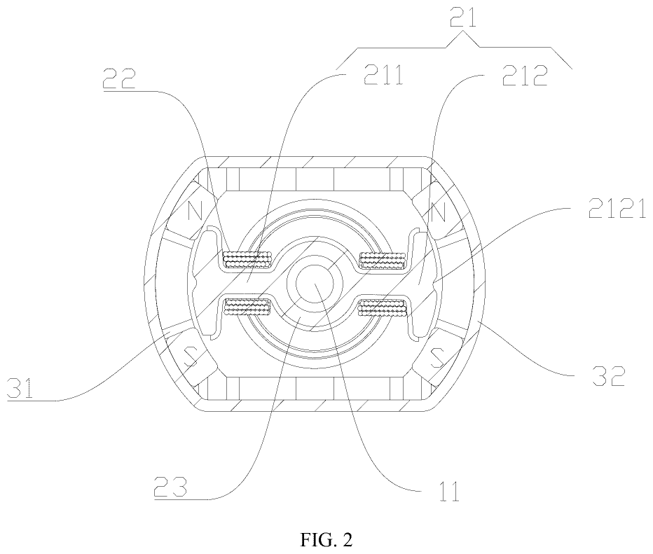

Referring to FIGS. 1 and 2, the motor according to the present disclosure includes the rotor shaft 1, the rotor member 2, the stator assembly 3, and the magnets 4, and the winding mounting arm 21 is designed to be symmetrical with one group of two magnets 4. The rotor member 2 and the stator assembly 3 realize energy conversion through electromagnetic interaction, the structure is compact, and torque output is efficient.

The rotor shaft 1 is usually made of high-strength alloy steel, and a surface is hardened. Both ends thereof are fixed to a motor shell 32 by precision ball bearings.

Furthermore, the rotor shaft 1 is provided with a fluid channel 11 extending in an extending direction of the rotor shaft 1. The fluid channel 11 may be configured to be in a linear shape, a spiral shape, or another shape according to design requirements. Taking the linear shape as an example, the fluid channel 11 is a circular channel that is coaxially arranged with the rotor shaft 1, and when liquid passes through the fluid channel 11, the rotor shaft 1 and the fluid channel 11 that rotate at a high speed still keep rotating around an axial direction, and no offset is generated, such that the rotor shaft 1, the fluid channel 11, and the liquid passing through the fluid channel 11 keep stable in a working state. The fluid channel 11 may deliver water or cleaning liquid to a cleaning accessory connected to the rotor shaft 1 by a driving element, such as a pump, so as to improve a cleaning capability.

The rotor member 2 is integrally formed by a magnetic conductive material in a cast mode, and includes a circular surrounding portion 23 at the center and the winding mounting arms 21 extending from the circular surrounding portion 23 in opposite directions in the radial direction of the rotor shaft 1, the circular surrounding portion 23 is fixedly connected, and the windings 22 are mounted around the winding mounting arms 21.

The stator assembly 3 is generally formed by laminating a plurality of annular silicon steel sheets, and wound around the rotor member 2. The stator assembly 3 further includes a shell 32 and a fixing base 31 with a shape adapted to that of the shell 32, and the magnet 4 is fixedly arranged in the fixing base 31; in the at least one plane perpendicular to the rotation axis of the rotor shaft 1, the shell 32 has a swing space for the rotor member 2 to swing around the rotor shaft 1 relative to the magnet 4, the swing space is defined by two arc sections and two linear sections, the two arc sections are arranged concentrically with the rotation axis of the rotor shaft 1, and the two linear sections are parallel to an extending direction of the winding mounting arm 21 at a balanced position. The arc section of the shell 32 is adapted to an arc section of the winding mounting arm 21, such that the rotor member 2 swings at the arc section of the shell 32, and the arrangement of the linear section compresses a space of the motor, such that an overall structure of the shell 32 of the motor is compact.

The magnets 4 and the winding mounting arms 21 are symmetrically designed, the two magnets 4 in the same group with opposite magnetic properties correspond to one winding mounting arm 21 and are fixedly arranged on the fixing base 31 of the stator assembly 3, and a shape of a section of the fixing base 31 is the same as that of the shell 32, such that the fixing base 31 can be inserted into the shell 32 to be fixed, and the distance between the magnets 4 is adjusted by changing fixed positions of the magnets 4 on the fixing base 31.

Since the cogging torque is affected by the arrangement positions of the magnets 4, in the at least one plane perpendicular to the rotation axis of the rotor shaft 1, the central angle α of the central lines of the two magnets 4 in the same group ranges from 40° to 50° with the intersection point of the rotation axis and the plane as the circle center.

The rotor shaft 1 rotates in a direction of a moment component to a first preset position when driven by the moment component in a circumferential direction of the rotation axis, and subsequently rotates in an opposite direction to a second preset position when driven by a moment component in the opposite direction. The first preset position is a position where a single-sided swing angle of the rotor member 2 reaches a maximum value, and the second preset position is a position where the rotor member 2 rotates in an opposite direction and the single-sided swing angle reaches the maximum value.

A working principle is as follows.

Referring to FIG. 1, at the balanced position, the position of the rotor member 2 is taken as a 0-degree angle position, i.e., the initial position, and the cogging torque is also 0 or close to 0. The rotor member 2 is turned to one side by a certain angle θ with the 0-degree angle position as a starting point, and this angle θ is the single-sided swing angle of the rotor member 2. When a forward current is applied to the motor, the electromagnetic torque pushes the rotor member 2 to swing towards an anticlockwise direction, the cogging torque and the electromagnetic torque are opposite, and in the swing process of the rotor member 2, the cogging torque is gradually increased, and when the single-sided swing angle of the rotor member 2 exceeds a preset swing angle value, the cogging torque is increased to be equal to the electromagnetic torque, the output torque is 0 at this point, and the single-sided swing angle of the rotor member 2 reaches the maximum value. When a reverse current is applied to the motor, the electromagnetic torque pushes the rotor member 2 to swing towards a clockwise direction, and after the rotor member 2 passes the 0-degree angle position, the cogging torque and the electromagnetic torque are opposite, and as in the case where the rotor member 2 swings anticlockwise, when the single-sided swing angle of the rotor member 2 exceeds the preset swing angle value, the cogging torque is increased to be equal to the electromagnetic torque, the output torque is 0 at this point, and the single-sided swing angle of the rotor member 2 reaches the maximum value. Thereafter, the above process is repeated. The preset swing angle value is the maximum value of the single-sided swing angle.

In an embodiment, in the at least one plane perpendicular to the rotation axis of the rotor shaft 1, the central angle α of the central lines of the two magnets 4 in the same group ranges from 44.5° to 45.5° with the intersection point of the rotation axis and the plane as the circle center.

Specifically, after multiple experiments, it is determined that when the central angle α of the central lines of the two magnets 4 in the same group ranges from 44.5°to 45.5°, the cogging torque is reduced, the electromagnetic force of the motor is increased, the maximum value of the single-sided swing angle of the rotor member 2 can meet required requirements, and a performance of the motor is better.

In an embodiment, in the at least one plane perpendicular to the rotation axis of the rotor shaft 1, an included angle β between adjacent sides of the two magnets 4 in the same group ranges from 35° to 45°.

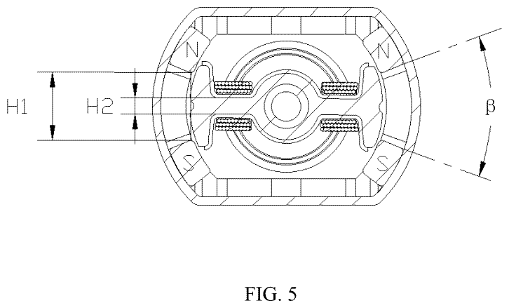

Referring to FIGS. 2 and 5, specifically, in the case where the central angle α of the central lines of the two magnets 4 in the same group is determined in the at least one plane perpendicular to the rotation axis of the rotor shaft 1, the included angle β between the adjacent sides of the two magnets 4 in the same group determines a shape of the magnets 4 and a minimum value of the distance between the sides. After multiple experiments, it is determined that when the included angle β between the adjacent sides of the two magnets 4 in the same group ranges from 35° to 45°, the cogging torque is reduced, the maximum value of the single-sided swing angle of the rotor member 2 can meet the required requirement, and the performance of the motor is better.

In an embodiment, the single-sided swing angle of the rotor member 2 ranges from 5° to 15°.

Referring to FIG. 1, specifically, by adjusting the central angle α of the central lines of the two magnets 4 in the same group and the included angle β between the adjacent sides of the two magnets 4 in the same group to be within preset values, the single-sided swing angle of the rotor member 2 is in the range of 5° to 15°, the maximum value of the single-sided swing angle of the rotor member 2 is 15°, and the rotor shaft 1 can carry the cleaning accessory to reach a cleaning range of 30°. In addition, since the cogging torque is small during starting, when the electromagnetic torque of the motor overcomes the cogging torque for outputting, the rotor member 2 can be controlled to swing between −15° and 15°, so as to realize adjustment of various swing modes.

In an embodiment, in the at least one plane perpendicular to the rotation axis of the rotor shaft 1, a ratio of a minimum value H1 of a side distance of the two magnets 4 in the same group to a width H2 of the corresponding winding mounting arm 21 of the rotor member 2 is 1:(1.15-1.22).

Referring to FIGS. 2 and 5, specifically, in the at least one plane perpendicular to the rotation axis of the rotor shaft 1, since the sides of the two magnets 4 are not parallel, the side distance close to the axis is small, and the side distance away from the axis is large. H1 is defined as the minimum value of the side distance of the two magnets 4 in the same group, and H2 is defined as the width of the arm rod portion 211 of the winding mounting arm 21. In the at least one plane perpendicular to the rotation axis of the rotor shaft 1, the ratio of the minimum value H1 of the side distance of the two magnets 4 in the same group to the width H2 of the corresponding winding mounting arm 21 of the rotor member 2 is 1:(1.15-1.22), and by defining the relative sizes, the distance between the magnets 4 and sizes of the winding mounting arms 21 are relatively determined, such that a magnetic flux within the winding 22 and magnetic field distribution meet design requirements.

In an embodiment, in the at least one plane perpendicular to the rotation axis of the rotor shaft 1, the minimum value H1 of the side distance of the two magnets 4 in the same group is 4 mm to 5 mm.

Specifically, the minimum H1 of the side distance of the two magnets 4 in the same group directly affects the distribution of a magnetic field generated by the magnet 4 and indirectly affects the magnetic flux of the winding 22, such that the cogging torque and the electromagnetic force of the motor meet the design requirements after multiple experiments.

In an embodiment, in the at least one plane perpendicular to the rotation axis of the rotor shaft 1, the minimum value H1 of the side distance of the two magnets 4 in the same group is 4.55 mm to 4.75 mm.

Specifically, after multiple experiments, it is determined that when the minimum value H1 of the side distance of the two magnets 4 in the same group is 4.55 mm to 4.75 mm in the at least one plane perpendicular to the rotation axis of the rotor shaft 1, the cogging torque is reduced, the maximum value of the single-sided swing angle of the rotor member 2 can meet the required requirement, and the performance of the motor is better.

In an embodiment, in the at least one plane perpendicular to the rotation axis of the rotor shaft 1, the rotor member 2 includes a circular surrounding portion 23 fixedly wound around the rotor shaft 1, the winding mounting arm 21 includes an arm rod portion 211 extending from the circular surrounding portion 23 towards the stator assembly 3 in the radial direction, and two stop portions 212 circumferentially extending from the arm rod portion 211 in opposite directions, and the winding 22 is wound around the arm rod portion 211.

Referring to FIG. 2, specifically, the circular surrounding portion 23 is used as a connecting portion of the rotor member 2 and the rotor shaft 1, is mainly configured to provide sufficient mechanical strength to support other components on the rotor member 2, and is fixedly connected with the rotor shaft 1 to drive the winding mounting arm 21 to swing.

The arm rod portions 211 are middle parts of the rotor member 2, extend from the circular surrounding portion 23 in opposite directions along the radial direction, and are symmetrically arranged at both sides of the rotor shaft 1 of the motor, and the winding 22 is wound on the arm rod portion 211.

Two stop portions 212 extend from a free end of each arm rod portion 211 along the circumferential direction, the complete arc section is formed by the two stop portions 212 and the free end of the arm rod portion 211, a length of a projection of the arc section in the radial direction is greater than the width of the arm rod portion 211, and the winding 22 is clamped on the arm rod portion 211 to be prevented from falling off from the arm rod portion 211.

In an embodiment, at the balanced position, the two magnets 4 of the same group are symmetrically arranged relative to the corresponding arm rod portion 211 of the winding mounting arm 21, and projections obtained when the two magnets 4 of the same group and the winding mounting arm 21 are subjected to a central projection in the radial direction with a point of the rotation axis as a projection center are partially overlapped.

Specifically, at the balanced position, the distances between the two magnets 4 in the same group and the winding mounting arm 21 are equal, and in the at least one plane perpendicular to the rotation axis of the rotor shaft 1, the two magnets 4 in the same group and the winding mounting arm 21 are centrally symmetrical relative to the point of the rotation axis, such that the magnetic field generated by the magnets 4 is uniformly distributed, and the related experiment of the motor is facilitated. Meanwhile, the cogging torque of the motor is 0 or close to 0 at this point, the starting is performed from the balanced position, a starting performance of the motor can be improved, and the motor can control the swing angle of the rotor member 2 through the electromagnetic force.

In an embodiment, within a range of swinging of the rotor member 2 around the rotor shaft 1 relative to the stator assembly 3 under the action of a magnetic force after the winding 22 is energized, a side of the stator assembly 3 facing the rotor member 2 is an arc surface, a side of the winding mounting arm 21 facing the stator assembly 3 is an arc surface, and a radial air gap between the two arc surfaces ranges from 0.1 mm to 0.2 mm.

Specifically, a width of the radial air gap affects magnetic circuit characteristics of the motor, and thus affects the cogging torque of the motor. When the width of the radial air gap is increased, magnetic resistance of the motor is increased due to an increase of a length of a magnetic path between the stator assembly 3 and the rotor member 2, such that the cogging torque of the motor is reduced. The width of the radial air gap further affects electromagnetic induction characteristics of the motor, and thus affects the cogging torque of the motor. When the width of the radial air gap is increased, magnetic field strength of the motor is reduced due to a reduction of magnetic flux density of the rotor member 2, resulting in a reduction of the cogging torque of the motor. Therefore, the increase of the width of the radial air gap can effectively reduce the cogging torque.

However, the increase of the width of the radial air gap results in a reduction of an efficiency and maximum torque of the motor, and therefore, a range of the width of the radial air gap needs to be reasonably selected. Preferably, the width of the radial air gap adopted in the motor according to the present disclosure ranges from 0.1 mm to 0.2 mm, such that the purpose of reducing the cogging torque of the motor is achieved, and meanwhile, the efficiency and the maximum torque of the motor are ensured to meet working requirements.

In an embodiment, a groove 2121 extending along the rotation axis is formed in the side of the winding mounting arm 21 facing the stator assembly 3 which is the arc surface, and at the balanced position, the groove 2121 is located between the two magnets 4 of the same group.

Specifically, the motor generates heat during working, the heat greatly affects the performance of the motor, and the groove 2121 can increase a surface area of the winding mounting arm 21, thereby facilitating faster heat dissipation. The design of the groove 2121 may improve mechanical strength of the winding mounting arm 21 and reduce the risk of damage to the rotor member 2 due to vibrations during rotation. The groove 2121 may also serve to more firmly fix the winding 22, so as to prevent the winding 22 from shifting or loosening during operation of the motor.

In an embodiment, the motor further includes an insulating layer 5, the insulating layer 5 being arranged between the winding 22 and the winding mounting arm 21 of the rotor member 2.

Specifically, direct contact between the winding mounting arm 21 and the winding 22 may cause an accident, such as a short circuit, and the insulating layer also prevents leakage of a current from the winding 22. Therefore, in order to improve an insulation performance between the winding 22 and other components, the insulating layer 5 is arranged between the winding 22 and the winding mounting arm 21 of the rotor member 2, the insulating layer 5 covers the circular surrounding portion 23, the arm rod portion 211 and a part of the stop portion 212 of the winding mounting arm 21, and only the arc section formed by the side of the stop portion 212 close to the stator assembly 3 and the free end of the arm rod portion 211 is exposed. The insulation performance is greatly improved.

In an embodiment, in the at least one plane perpendicular to the rotation axis of the rotor shaft 1, the width H2 of the winding mounting arm 21 of the rotor member 2 is 5 mm to 6 mm.

Specifically, the width H2 of the winding mounting arm 21 of the rotor member 2 directly affects the magnetic flux of the winding 22, and affects the electromagnetic force and the cogging torque of the motor, and through multiple experiments, the cogging torque and the electromagnetic force of the motor reach the design requirements.

In an embodiment, in the at least one plane perpendicular to the rotation axis of the rotor shaft 1, the width H2 of the winding mounting arm 21 of the rotor member 2 is 5.45 mm to 5.55 mm.

Specifically, after multiple experiments, it is determined that when the width H2 of the winding mounting arm 21 of the rotor member 2 is 5.45 mm to 5.55 mm in the at least one plane perpendicular to the rotation axis of the rotor shaft 1, the cogging torque is reduced, the maximum value of the single-sided swing angle of the rotor member 2 can meet the required requirement, and the performance of the motor is better.

In an embodiment, in the at least one plane perpendicular to the rotation axis of the rotor shaft 1, a section of the magnet 4 is in an arc shape, and the magnet 4 includes an outer arc section and an inner arc section distributed in the radial direction, as well as two sides respectively connected with two corresponding ends of the outer arc section and the inner arc section; central angles corresponding to the outer arc section and the inner arc section are the same.

Specifically, the central angles corresponding to the outer arc section and the inner arc section are the same, that is, the inner arc section and the outer arc section are concentric and have different radii, which is helpful for ensuring radial consistency of the magnetic field, such that the magnetic field inside the motor is more uniform. The two sides are connected with the inner arc section and the outer arc section, and meanwhile may generate unnecessary magnetic flux loss or interference due to edge effect of the magnetic field, such that linear sides are required to be adopted to facilitate limiting of sizes of the sides, so as to reduce an influence on the magnetic field as much as possible, and the uniform magnetic field can help the motor to realize a better performance. Therefore, the sectional shape of the magnet 4 including the outer arc section, the inner arc section and the two sides connected with the two sections is adopted to ensure uniformity of the magnetic field and maximize use of a space.

In an embodiment, in the at least one plane perpendicular to the rotation axis of the rotor shaft 1, the side has a length of 1 mm to 1.5 mm.

Specifically, the length of the side of the magnet 4 determines the size of the magnet 4, and is an important factor for determining the magnetic field distribution. Since an edge region of the magnet 4 usually has a strong local magnetic field change, when the length of the magnet 4 is increased, the magnetic field generated in a length direction may be more uniform, magnetic force lines have more paths to follow instead of being concentrated at two ends, and therefore, the cogging torque of the motor can be changed by changing the length of the side of the magnet 4. After multiple experiments, it is determined that when the length of the side is 1 mm to 1.5 mm and more preferably 1.2 mm in the at least one plane perpendicular to the rotation axis of the rotor shaft 1, the cogging torque of the motor and the maximum value of the single-sided swing angle of the rotor member 2 can meet the required requirements, and the performance of the motor is better.

In addition to the above motor applied to an oral cleaning device, the present disclosure provides an oral cleaning device, including a body, a cleaning accessory movably arranged on the body, and a motor arranged in the body, wherein the motor is configured to drive the cleaning accessory to swing through a rotor shaft, and the motor is the motor according to any one of the above embodiments.

Specifically, the oral cleaning device includes an electric toothbrush, an electric oral irrigator, a tongue cleaner, or the like, the adoption of the motor according to the present disclosure can improve a load resisting capability of the oral cleaning device, running is stable, and meanwhile, the swing amplitude of the cleaning accessory is increased to improve an oral cleaning capability of the oral cleaning device.

In an embodiment, the oral cleaning device further includes a pump, a liquid outlet end of the pump being in communication with the fluid channel 11 of the rotor shaft 1.

Specifically, the oral cleaning device is further provided with a water tank, and the water tank is connected with the pump through a pipeline. The pump provides a sufficient pressure to move liquid from the water tank through the pipeline and the fluid channel 11 of the rotor shaft 1 to the cleaning accessory, and the oral cleaning device helps to remove food residues and dental plaque between teeth by using the liquid, thereby improving the oral cleaning capability of the oral cleaning device.

The embodiments of the present disclosure are described above, and the above description is exemplary, not exhaustive, and not limited to the disclosed embodiments. Many modifications and variations will be apparent to those of ordinary skill in the art without departing from the scope and spirit of the described embodiments. The terminology used herein is chosen to best explain the principles of the embodiments, the practical application, or technical improvements in the market, or to enable others of ordinary skill in the art to understand the embodiments disclosed herein. The scope of the present disclosure is defined by the appended claims.

What is claimed is:

1. A motor, comprising:
a rotor shaft (1);
a rotor member (2) fixedly arranged on the rotor shaft (1) and having two winding mounting arms (21) extending in opposite directions in a radial direction of the rotor shaft (1), the winding mounting arms (21) being configured to mount windings (22);
a stator assembly (3) arranged around the rotor member (2); and
two groups of magnets arranged on the stator assembly (3) and corresponding to the two winding mounting arms (21) respectively, each group of magnets comprising two magnets (4) with opposite magnetic properties;
wherein in at least one plane perpendicular to a rotation axis of the rotor shaft (1), a central angle α of central lines of the two magnets (4) in the same group ranges from 40° to 50° with an intersection point of the rotation axis and the plane as a circle center.

2. The motor according to claim 1, wherein in the at least one plane perpendicular to the rotation axis of the rotor shaft (1), the central angle α of the central lines of the two magnets (4) in the same group ranges from 44.5° to 45.5° with the intersection point of the rotation axis and the plane as the circle center.

3. The motor according to claim 2, wherein a single-sided swing angle of the rotor member (2) ranges from 5° to 15°.

4. The motor according to claim 3, wherein in the at least one plane perpendicular to the rotation axis of the rotor shaft (1), a ratio of a minimum value H1 of a side distance of the two magnets (4) in the same group to a width H2 of the corresponding winding mounting arm (21) of the rotor member (2) is 1:(1.15-1.22).

5. The motor according to claim 4, wherein in the at least one plane perpendicular to the rotation axis of the rotor shaft (1), the minimum value H1 of the side distance of the two magnets (4) in the same group is 4 mm to 5 mm.

6. The motor according to claim 5, wherein in the at least one plane perpendicular to the rotation axis of the rotor shaft (1), the minimum value H1 of the side distance of the two magnets (4) in the same group is 4.55 mm to 4.75 mm.

7. The motor according to claim 4, wherein in the at least one plane perpendicular to the rotation axis of the rotor shaft (1), the rotor member (2) comprises a circular surrounding portion

(23) fixedly wound around the rotor shaft (1), the winding mounting arm (21) comprises an arm rod portion (211) extending from the circular surrounding portion (23) towards the stator assembly (3) in a radial direction, and two stop portions (212) circumferentially extending from the arm rod portion (211) in opposite directions, and the winding (22) is wound around the arm rod portion (211).

8. The motor according to claim 4, wherein at a balanced position, the two magnets (4) of the same group are symmetrically arranged relative to the corresponding arm rod portion (211) of the winding mounting arm (21), and projections obtained when the two magnets (4) of the same group and the winding mounting arm (21) are subjected to a central projection in the radial direction with a point of the rotation axis as a projection center are partially overlapped.

9. The motor according to claim 6, wherein within a range of swinging of the rotor member (2) around the rotor shaft (1) relative to the stator assembly (3) under the action of a magnetic force after the winding (22) is energized, a side of the stator assembly (3) facing the rotor member (2) is an arc surface, a side of the winding mounting arm (21) facing the stator assembly (3) is an arc surface, and a radial air gap between the two arc surfaces ranges from 0.1 mm to 0.2 mm.

10. The motor according to claim 7, wherein a groove (2121) extending along the rotation axis is formed in the side of the winding mounting arm (21) facing the stator assembly (3) which is the arc surface, and at the balanced position, the groove (2121) is located between the two magnets (4) of the same group.

11. The motor according to claim 7, further comprising an insulating layer (5), the insulating layer (5) being arranged between the winding (22) and the winding mounting arm (21) of the rotor member (2).

12. The motor according to claim 4, wherein in the at least one plane perpendicular to the rotation axis of the rotor shaft (1), the width H2 of the winding mounting arm (21) of the rotor member (2) is 5 mm to 6 mm.

13. The motor according to claim 12, wherein in the at least one plane perpendicular to the rotation axis of the rotor shaft (1), the width H2 of the winding mounting arm (21) of the rotor member (2) is 5.45 mm to 5.55 mm.

14. The motor according to claim 1, wherein the stator assembly (3) further comprises a shell (32) and a fixing base (31) with a shape adapted to that of the shell (32), and the magnet (4) is fixedly arranged in the fixing base (31);
in the at least one plane perpendicular to the rotation axis of the rotor shaft (1), the shell (32) has a swing space for the rotor member (2) to swing around the rotor shaft (1) relative to the magnet (4), the swing space is defined by two arc sections and two linear sections, the two arc sections are arranged concentrically with the rotation axis of the rotor shaft (1), and the two linear sections are parallel to an extending direction of the winding mounting arm (21) at the balanced position.

15. The motor according to claim 1, wherein in the at least one plane perpendicular to the rotation axis of the rotor shaft (1), a section of the magnet (4) is in an arc shape, and the magnet (4) comprises an outer arc section and an inner arc section distributed in the radial direction, as well as two sides respectively connected with two corresponding ends of the outer arc section and the inner arc section; central angles corresponding to the outer arc section and the inner arc section are the same.

16. The motor according to claim 15, wherein in the at least one plane perpendicular to the rotation axis of the rotor shaft (1), the side has a length of 1 mm to 1.5 mm.

17. The motor according to claim 1, wherein the rotor shaft (1) is provided with a fluid channel (11) extending in an extending direction of the rotor shaft (1).

18. The motor according to claim 1, wherein the rotor shaft (1) rotates in a direction of a moment component to a first preset position when driven by the moment component in a circumferential direction of the rotation axis, and subsequently rotates in an opposite direction to a second preset position when driven by a moment component in the opposite direction.

19. An oral cleaning device, comprising a body, a cleaning accessory movably arranged on the body, and a motor arranged in the body, wherein the motor is configured to drive the cleaning accessory to swing through a rotor shaft (1), and the motor is the motor according to claim 1.

20. The oral cleaning device according to claim 19, further comprising a pump, a liquid outlet end of the pump being in communication with the fluid channel (11) of the rotor shaft (1).
